(19) United States
(12) Patent Application Publication
(10) Pub. No.: US 2004/0088913 A1
(43) Pub. Date: May 13, 2004

(54) Method and apparatus for the protection of plantations against frost damage

(76) Inventor: Melhm Salim Salomon Namor, Guildford (GB)

Correspondence Address: JACOBSON HOLMAN PLLC, 400 SEVENTH STREET N.W., SUITE 600, WASHINGTON, DC, 20004, US

(21) Appl. No.: 10/683,048

(22) Filed: Oct. 14, 2003

(30) Foreign Application Priority Data
Apr. 10, 2002 (GB) 0208290.7

(51) Int. Cl. A01G 13/00

(52) U.S. Cl. 47/2

(57) ABSTRACT

Apparatus for discharging thermal fog comprising a heating device incorporating a combustion chamber (2) and an outlet flue for discharging combustion gases from the combustion chamber, and a steam generating chamber (7) in heat exchange relationship with said combustion chamber and having a steam discharge outlet (13), whereby said combustion gases and said steam can, in use, be discharged in a mixture in a generally horizontal direction.

### BACKGROUND OF THE INVENTION

This invention concerns a method and apparatus for use in the protection of plantations against frost damage.

Several methods for the Protection of Plants against frost damage have been developed, all of them trying to maintain the air temperature in the plantation above the critical −0.5° C. level, below which the sap in the plant freezes damaging its tissues on an irreversible way.

Among all known methods of frost protection for plants and crops, (Reiger 1989, Perry 2001), only the two following described are more commercially used:

(i) Sprinkler Irrigation: bases its protective effect on the introduction of heat i.e.: the Latent Heat of Solidification that is liberated when water solidifies into ice maintaining the temperature equal to 0° C. during the changing of states from liquid to solid provided that the two phases, liquid and solid be present. This method implies a constant spraying of water over the entire plantation at all time during which atmospheric temperature falls below 0° C.

The problems associated with this method are as follows:

high initial investment on pumping equipment, piping and sprinklers.

large and costly reservoirs of water are needed.

destruction of plants which can occur due to the weight of the ice that accumulates on the plants at temperatures below minus(−) 6° C.

drenching the plantation soil and water-logging the plant roots making them prone to moulds attack.

heavy contamination of underground aquifers with leached nutrients and agrochemical.

(ii) The Burning of Fuel in Heaters or Open Recipients: this method bases its protective abilities on the heat given out by the burning of various types of fuel, fuel oil, tar, and as is often the case, pre-used lubricants and even rubber tyres which are burnt directly onto the plantation soil with production of highly pollutant black smokes. In this method, most of the heat of combustion ascends with the combustion gases through the cold air on the plantation by convections to dissipate uselessly into space above the plantation. A heat balance using reported values, (Riegel 1989) indicates that the heat lost exceeds 95% of the heat generated by the combustion.

Further problems associated with this system are as follows:

limited effectiveness at temperatures below −5/−6° C.

high fuel wastage through heat loss into space

high degree of pollution on the plantation and on the environment.

the system is not permitted for Organic production.

(iii).—The Artificial Fog System: such methods have been the motive behind various studies and patents {(Bydeer et al (1959); Mihara (1967); Henderson (1972); Mee (1975); Rieger (1989); Synder et al (1993) and others} and is utilised to protect plantations against RADIATIVA frost, so-called due to that fact that it occurs in cloud-free skies when the heat of the ground is lost as it is irradiated into the sky.

With this method, the intention is to create a fog at plantation level similar to that of a clouded sky, that is, a sort of “green house effect” to prevent the escape by radiation of the remaining heat still on the plantation before freezing and in doing so to avoid the production of the frost.

The problems associated with the Artificial Fog acting as Thermal Barrier method are as follows:

Practical difficulties and high cost of obtaining the right size of water drop in the fog, as produced by natural clouds, for it to stop the escape of radiated heat by reflecting it back to the ground.

short life and quick settling and disappearance of the artificial fog so created. These difficulties, and poor results have led to practically abandonment of the method to date.

Bibliography:

Mihara, Y.—U.S. Pat. No. 3,330,069 (1967)

Henderson, G. L.—U.S. Pat. No. 3,654,175 (1972)

Mee, T. R.—U.S. Pat. No. 3,894,692 (1975)

Bydeer, E. L., Lower M. D.—“Frost Protection with Artificial Fog”—New Scientific Journal of Experimental Agriculture (1985,13, pp.195-9).

Rieger, M.—“Freeze Protection for Horticultural Crops”—Horticultural Review, Timber Press, 1989, 11, pp.45-109.

Synder, R. L. and Cornell, J. H.—“Ground Cover Height affects pre-down orchard floor temperature”—Californian Agriculture (1993, 47, pp 9-12)

Perry, K. B.—“Frost/Freeze Protection for Horticultural Crops”—North Carolina State Univ. Ext. Serv. Leaflet Review HIL—705 (2001)

Various forms of apparatus have also been proposed for the protection of crops from frost, in published Patent Specifications, see example GB 986691, U.S. Pat. No. 5,010,872, U.S. Pat. No. 3,055,144, U.S. Pat. No. 2,154,002 and RU 20288762. Such apparatus have proved very high in capital cost and have the disadvantage that the area capable of being protected in relation to the size and capital cost of each unit is relatively low.

### SUMMARY OF THE INVENTION

It is an object of the present invention to provide an improved means for the protection of plantations against frost damage, that overcomes or at least reduces the disadvantages of the prior methods referred to above.

The invention accordingly provides an apparatus for use in the protection of plants from frost damage comprising; a combustion chamber for the burning of fuel, said combustion chamber including inlet means for receiving ambient air and a generally horizontal upper heat exchange surface; an upright outlet flue extending from said combustion chamber and provided at its upper end with a plurality of radially extending outlet ducts; a water vapourisation chamber having a lower, water receiving surface in heat exchange relationship with said upper heat exchange surface of the combustion chamber, steam outlet means extending from said vapourisation chamber and providing a plurality of steam outlet jets each located within a said outlet duct of said outlet flue, adjustable means for introducing ambient air into flue exhaust gases to be discharged from said outlet ducts, and a water supply means for controlling the supply of water to said lower water receiving surface, the arrangement being such that, in use, the convection of exhaust gases within said flue and the discharge of steam from said outlet jets is effective to provide from said outlet ducts a forced generally horizontal discharge of thermal fog comprising water vapour dispersed in exhaust gas at a temperature that is above that of ambient atmosphere and the density of which is controllable by adjustment of said ambient air introducing means.

A device in accordance with the invention has the advantage that it can form a self contained unit that is readily portable and of inexpensive construction so that a number of such units can be readily deployed manually in order to protect a given area. For example units can be of such a scale that the total weight is in the region of 12 kilograms. Thus it is envisaged that from 20 to 40 units per hectare of crop could be manually installed for protection of a given area.

Further features and advantages of the invention will become apparent from the following description taken in conjunction with the drawings and the dependent claims.

### BRIEF DESCRIPTION OF THE DRAWINGS

FIG. 1 is a perspective view of an apparatus in accordance with the invention,

FIG. 2 is a sectional elevation of the apparatus showing in FIG. 1,

FIG. 3 is a fragmentary view corresponding to FIG. 2 and shown on an enlarged scale, and

FIG. 4 is a horizontal section taken on the line IV-IV of FIG. 2.

### DETAILED DESCRIPTION OF PREFERRED EMBODIMENTS

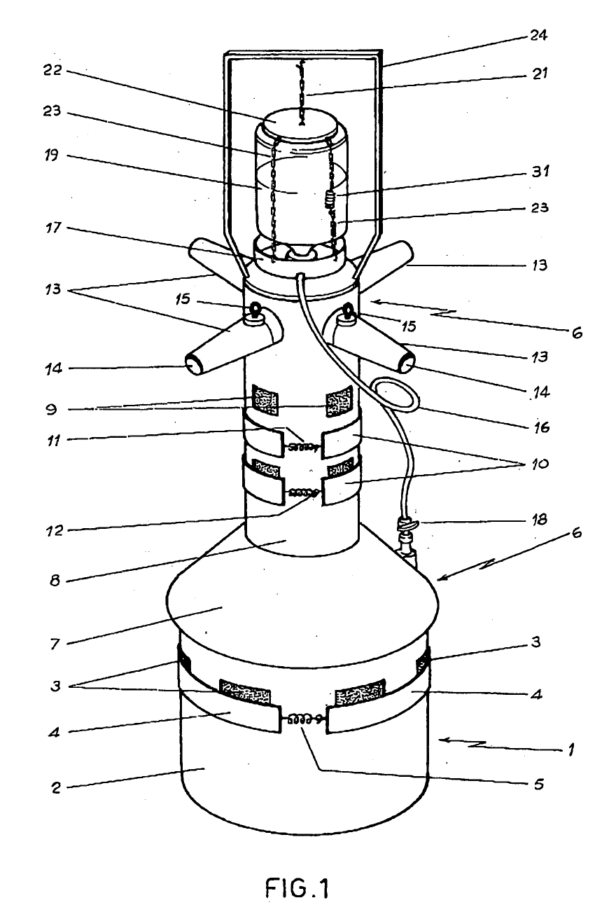

As illustrated in FIG. 1, a device according to one embodiment of the invention comprises a combustion section 1 of a cylindrical storage tank and combustion chamber 2 for the burning of the fuel, which can be liquid, solid, liquid and solid mixtures, gas or bio-combustible this chamber 2 has a plurality of windows 3 on its lateral surface through which the air needed for the combustion can enter, the flow rate of which can be regulated by means of an external belt 4.

In order to regulate the rate of combustion, the operator displaces vertically the bolt 4, which is adjusted by mean of the spring 5, to the corresponding position for the rare of combustion required to evaporate a determined volume of water into steam.

A detachable section for production of steam, mixing the steam with the combustion gases and ejection of the Thermal Fog is indicated with the general reference 6. It consists of a conical shaped vaporisation or steam chamber 7 whose base rests closing the cylindrical chamber 2 for storage and burning of the fuel. Trough the centre of the said vaporisation chamber 7 rises vertically a chimney 8 whose lateral wall possess a plurality of windows 9, which permit the entrance of fresh air needed to cool down the temperature of the ascending combustion gases, and hence increase the density of the Thermal Fog that is distributed over the plantation. The windows 9 can be partially or totally covered by displaceable external belts 10 provided with an adjusting spring 11 and a hook device 12 which makes possible the regulation of the air flow.

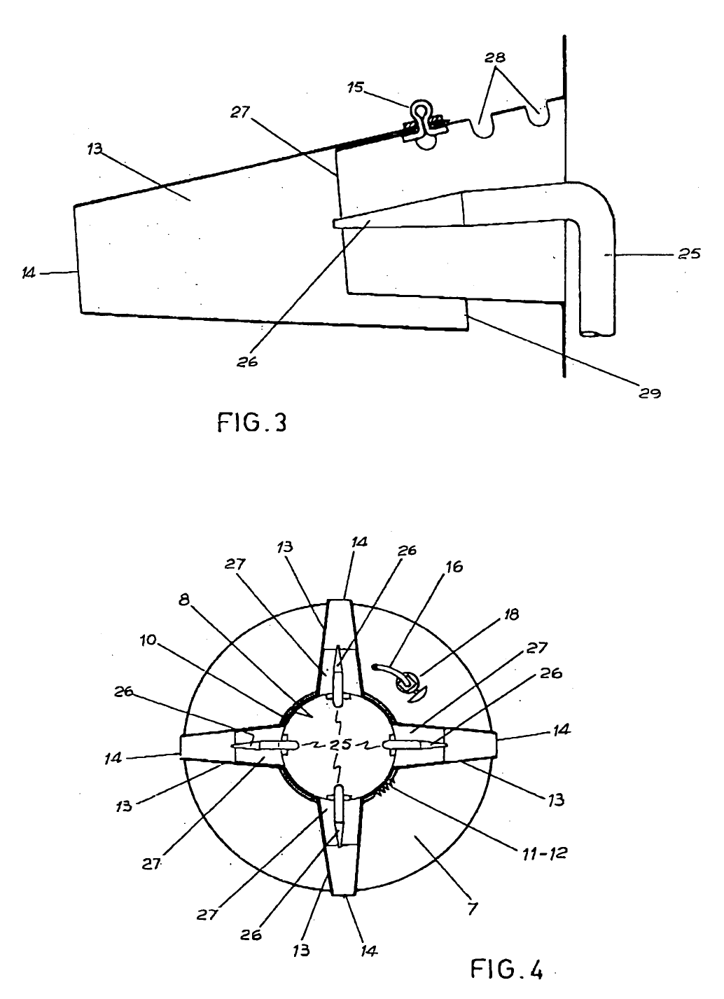

As shown the chimney 8 has on its superior end a plurality of thermal fog ejectors 13 formed by sliding conically-shaped cases projecting radially, and through whose openings 14 the Thermal Fog is ejected into the plantation space. As it will be seen from FIG. 3 and FIG. 4, those ejectors of Thermal Fog 13 can be displaced and fixed in various axial positions by using the releasable fastenings 15.

A flexible tube 16 connected to a tray with constant-water level 17 feeds the vaporisation chamber 7 during the production of steam, the feeding of water being controlled by a valve 18 and regulated by a float valve 30 within the steam chamber 7. An inverted container 19 resting on two stops 20 administers the water required to the constant level tray 17 each time the water surface on it permits the entrance of an air bubble into the container 19. As can be seen in FIG. 1 both the constant-water level tray 17 as well as inverted container 19 are supported by a central chain 21 joined at plate 22 adjacent to the base of the container. The perimetral chains 23 link this plate 22 keeping the vertical position of the container while the hook and chain 21 allow a quick removal of the container 19 for refilling.

The selective hooking of the central chain 21 to the supporting frame 24 which is bolted to the chimney 8, allows for the variation of the height of tray 17 in respect to the vaporisation chamber 7 therefore varying the height of the water column which gives the pressure for the feeding water to enter into the vaporisation chamber 7 against the prevailing steam pressure within it.

As previously mentioned, the fixing of the steam pressure in the vaporisation chamber 7 via the adjustment of the height of constant water level tray 17, in conjunction with the production of steam fixed via the combustion rate regulated through the position of the belt 4 over the windows 3 on the combustion chamber 1 permits regulation of the amplitude or extent of the thermal fog in the field and therefore the required number of units per hectare to protect the plantation according the climate conditions expected.

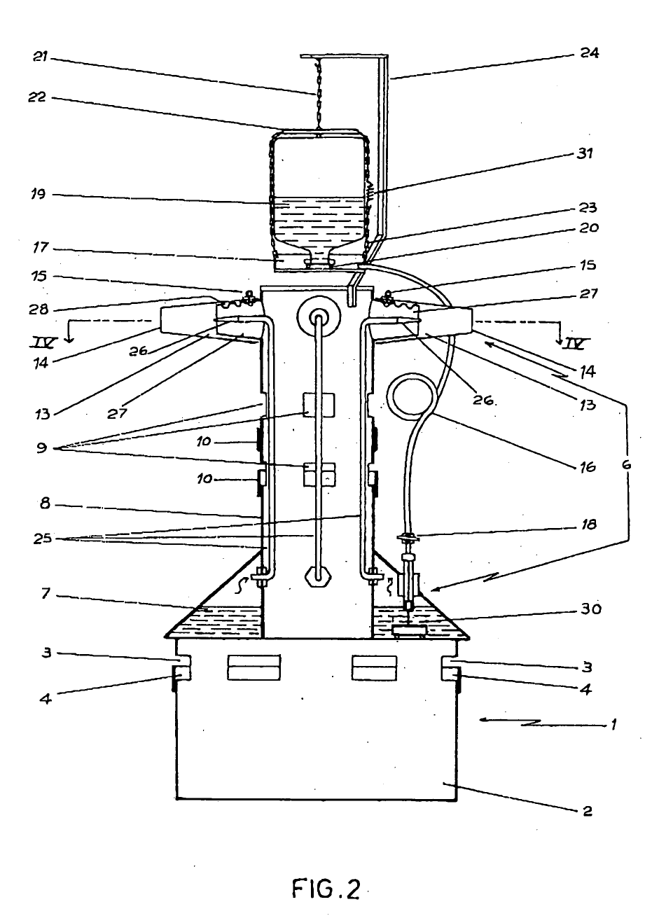

FIG. 2 shows a longitudinal cross-section of the device, in which can be seen the storage and combustion chamber 2 over which is placed the detachable part that generates the steam and mixes it with the combustion gases, (and air) indicated with the general reference 6.

The steam produced in the vaporisation chamber 7 is conducted through a plurality of pipes 25 which run along the wall of the chimney 8, each ending in a converging nozzle intended to accelerate the ejection of steam and constituting steam ejectors 26 which project in a radial fashion. These steam ejectors 26 are located concentrically on the inside of conical ducts 27 fixed on the top of chimney 8 to redirect the ascending combustion gases through the chimney also into a radial horizontal direction.

As can be seen, also in FIG. 3 and FIG. 4, each of the conical ducts 27 are covered by a conical case, the Thermal Fog Jets 13, which can be fixed in different positions via the fasteners 15 that pass through perforations 28 in both pieces. There can also be seen the Venturi arrangements formed by the steam jots 26, the fixed conical ducts 27 and the conical cases 13 or Thermal Fog Ejectors.

Thus it will be seen that the device described above uses the evaporation of water to incorporate and retain at plantation level part of the heat generated by the combustion of fuel and then using the steam produced to mix with the combustion gases which contain the rest of the combustion heat to form the Thermal Fog at plantation level. This Thermal Fog with its heat load is then ejected as a plurality of horizontal jets into the plantation space where it transfers its heat load, raising effectively the temperature of the plants, soil and air, and thus preventing the damaging effects of the frost. The ejection and dispersal of the Thermal Fog is produced using the motor impulse of the steam under pressure generated in the system, and driven through the Venturi type devices. It is also this motor impulse that is used to incorporate fresh air as a third component in the formation of the Thermal Fog in order to increase its density, therefore increasing its possibility to remain at the plantation level for longer time to complete the transfer of its heat load raising the temperature of the plantation and preventing the occurrence of frost. The big difference in comparison with the known method above described is that in accordance with this invention the Thermal Fog has been used first as a tool to retain the combustion heat at plantation level and the, as a transport vehicle to carry and distribute all the combustion heat to warm the plantation up while in the known method the cold fog produced in a different way has no significant heat content to transfer and is only intended to act as a roof, or as a thermal barrier over the plantation in the same way that the clouds in the sky at night prevent the occurrence of frost on the earth surface.

The device according to the invention also allows for the distribution of the Thermal Fog both radially as well as vertically whilst allowing the regulation or adjustment of its reached distance, to reduce substantially the required number of units/hectare to protect the plantation. On the other hand, the possibility to select the chemical composition to produce the Thermal Fog makes this invention suitable also for the protection of Organic Plantations.

In the described arrangements, each conical case 13 can slide axially over the fixed conical ducts 27. Depending on the position of the conical case relative to the fixed conical duct, an aperture with the form of an eccentric ring is loft between the two pieces through which the Venturi system sucks-in cold air that enters as a third component of the Thermal Fog. In this way, it is possible to adjust the proportion of cold air and gases of combustion that are mixed with the steam, thereby making it possible to regulate the density of the Thermal Fog to reduce its buoyancy on the external cold air, therefore increasing the time and the efficiency of the transference of its heat load into the plantation space. Thus, the density of the Thermal Fog can then be varied as follows:

Maximum Density: with conical cases 13 removed from the fixed conical ducts 27, the combustion gases will exhaust separately and ascend without mixing. Thus the Thermal Fog will be formed by the steam jets only.

Minimum Density: with the conical cases fixed at top position covering the fixed conical ducts, and the Chimney windows closed, thus the Thermal Fog will be formed by the Steam jets and the hottest combustion gases only.

Intermediate Densities: obtained with conical cases 13 in intermediate position with the fixed conical ducts and Chimney windows open half-way the Thermal Fog will be a mix of steam, combustion gases and variable influx of cold air.

As already mentioned above, units of the kind described can be of light weight and be readily manually portable. Thus a suitable number of units can be installed over a given area in order to give more effective protection than would be the case with larger scale units of high capital cost.

1. An apparatus for use in the protection of plants from frost damage comprising; a combustion chamber for the burning of fuel, said combustion chamber including inlet means for receiving ambient air and a generally horizontal upper heat exchange surface; an upright outlet flue extending from, said combustion chamber and provided at its upper end with a plurality of radially extending outlet ducts; a water vapourisation chamber having a lower, water receiving surface in heat exchange relationship with said upper heat exchange surface of the combustion chamber, steam outlet means extending from said vapourisation chamber and providing a plurality of steam outlet jets each located within a said outlet duct of said outlet flue, adjustable means for introducing ambient air into flue exhaust gases to be discharged from said outlet ducts, and a water supply means for controlling the supply of water to said lower water receiving surface, the arrangement being such that, in use, the convection of exhaust gases within said flue and the discharge of steam from said outlet jets is effective to provide from said outlet ducts a forced generally horizontal discharge of thermal fog comprising water vapour dispersed in exhaust gas at a temperature that is above that of ambient atmosphere and the density of which is controllable by adjustment of said ambient air introducing means.

2. An apparatus according to claim 1, wherein said ambient air introducing means comprises one or more adjustable air inlet apertures provided in said exhaust gas flue.

3. An apparatus according to claim 1 wherein each steam outlet jet is located coaxially with the said outlet duct.

4. An apparatus according to claim 1 wherein each said outlet duct is of tapering conical configuration and is located within a conically tapering venturi outlet defining an inlet aperture for ambient air between the outer wall of said outlet nozzle and the inner wall of the venturi outlet, said venturi outlet being axially adjustable relatively to said outlet nozzle, in order to provide a said adjustable ambient air introducing means.

5. An apparatus according to claim 1, wherein said combustion chamber is of generally upright cylindrical construction, said exhaust gas flue comprises a chimney extending vertically from the central axis of said combustion chamber, said steam generating chamber comprises an annular chamber surrounding said chimney and having a tray closing said combustion chamber and providing said water receiving surface.

6. An apparatus according to claim 1 wherein said water supply means comprises a water reservoir providing gravity feed of water to said water receiving surface and a float valve for regulating the level of water above said surface.

7. An apparatus according to claim 1, wherein the said air inlet means of the combustion chamber are adjustable to vary the rate of flow of air for combustion and thus the rate of combustion of fuel within the combustion chamber.
